(19) United States
(12) Patent Application Publication
(10) Pub. No.: US 2003/0199379 A1
(43) Pub. Date: Oct. 23, 2003

(54) Software lock for centrifuge functions

(75) Inventors: Harvey Schneider, Southbury, CT (US); Vijay Mehta, Bethel, CT (US); Karl Kregling, Seymour, CT (US); Suzanne Anderson, Bethlehem, CT (US)

Correspondence Address: BAKER & HOSTETLER LLP, Washington Square, Suite 1100, 1050 Connecticut Avenue, N.W., WASHINGTON, DC, 20036, US

(73) Assignee: Kendro Laboratory Products, LP

(21) Appl. No.: 10/417,172

(22) Filed: Apr. 17, 2003

Related U.S. Application Data
(60) Provisional application No. 60/373,619, filed on Apr. 19, 2002.

(51) Int. Cl. B04B 13/00

(52) U.S. Cl. 494/11

(57) ABSTRACT

Methods and apparatus for a centrifuge lock for use in centrifuge systems, which are particularly suited for centrifuge lock touch screen controls which can be manually set to unlock the centrifuge for easy access without the need for a physical key.

### PRIORITY

This application claims priority to the provisional U.S. patent application entitled SOFTWARE LOCK FOR CENTRIFUGE FUNCTIONS, filed Apr. 19, 2002, having a serial No. 60/373,619, the disclosure of which is hereby incorporated by reference.

### FIELD OF THE INVENTION

The present invention relates generally to separation system access authorization. More particularly, the present invention relates to a centrifuge lock system for access control.

### BACKGROUND OF THE INVENTION

A centrifuge instrument is a separation device by which liquid samples may be subjected to centripetal forces. The sample is placed in a container such as a test tube, which is then carried within a member known as a centrifuge rotor. The rotor is mounted to a rotatable drive shaft that is connected to a source of motive energy.

Centrifuges currently employed in laboratories are generally operated by manual controls using various settings and procedures. A rotor control may be used to set the centrifuge to a specific sized rotor or type of rotor. A temperature control and timer are also frequently used depending on the type of sample being tested. There are conventional power switches to manually turn the units on or off as needed. A physical key lock is commonly used to secure centrifuge access from operation.

However, if a user desires to have a centrifuge readily available for samples, the physical key must be obtained in order to operate the centrifuge. If the key is misplaced or worn, then the user will either be delayed or unable to operate the centrifuge. As a result, samples and/or time may be lost.

The present invention overcomes the prior art problems by utilizing a touch screen centrifuge lock control that is capable of manually locking and unlocking the centrifuge, so that easy access is available without the need for a physical key.

Additionally, current systems do not protect against unauthorized run parameter, or program memory changes, or the possibility for operator error, any of which can adversely affect process control.

The present invention overcomes this concern by providing a centrifuge lock control that can be used to set the run parameters of the centrifuge and keep those parameters from being altered by a user of the centrifuge.

Accordingly, a software lock for centrifuge functions that can limit access to and the function of a centrifuge is desired.

In addition, a software lock for centrifuge functions that can accept supervisory and user-level passwords to operate the centrifuge is also desired.

### SUMMARY OF THE INVENTION

It is therefore a feature of the present invention to provide a software lock for limiting the access to and function of a centrifuge.

It is another feature of the present invention to provide a software lock for centrifuge functions with the ability to accept supervisory and user-level passwords.

The above and other features are achieved through the use of a novel software lock for centrifuge functions and methods as herein disclosed. In accordance with the present invention, a controller is provided for use with a centrifuge. The controller may be connected to the centrifuge. The controller accepts a password to operate the separation system.

The controller is capable of activating and deactivating, or locking and unlocking, the centrifuge. This capability permits limiting the access to and function of the centrifuge. The controller is capable of accepting a supervisory password to lock the centrifuge in single run mode or repeat run mode. When locked by a supervisory password, the controller may only be unlocked by a supervisory password. However, if the centrifuge was locked by an end user password, it can also be unlocked by an end user password.

The controller is also capable of saving in memory the parameters for a centrifuge run or series of runs. The controller is capable of accepting a supervisory password to set run parameters. The controller is also capable of accepting an end user level password, which can operate the centrifuge without changing the parameters.

In accordance with one embodiment of the present invention, a software lock is provided for use with a centrifuge. The software lock permits a supervisor to prevent a user from changing some or all parameters of a centrifuge run. The supervisor can also limit the operation of the centrifuge to a single run. Or, the supervisor can prevent any use of the centrifuge through the use of the software lock. The software lock also permits for supervisory override of the parameters for a centrifuge run. The goal is to prevent unauthorized changes to run parameters.

The user-level password can only unlock the centrifuge if a user-level password was used to lock the centrifuge. A supervisory password can always unlock the centrifuge.

The present invention also provides for a method for limiting the function of a centrifuge. The method includes unlocking the centrifuge, entering the run parameters for the centrifuge, and locking the centrifuge.

The present invention also provides a software lock with means for unlocking the centrifuge, means for entering the run parameters for the centrifuge, and means for locking the centrifuge.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a flowchart of the steps in a preferred embodiment of the invention.

FIG. 2 is a block diagram of a centrifuge with a controller according to a preferred embodiment of the present invention.

FIG. 3 is a screen interface of one preferred embodiment of the present invention showing centrifuge lock protocols.

FIG. 4 is a screen interface of one preferred embodiment of the present invention showing that the centrifuge system is in lock mode.

### DETAILED DESCRIPTION OF THE INVENTION

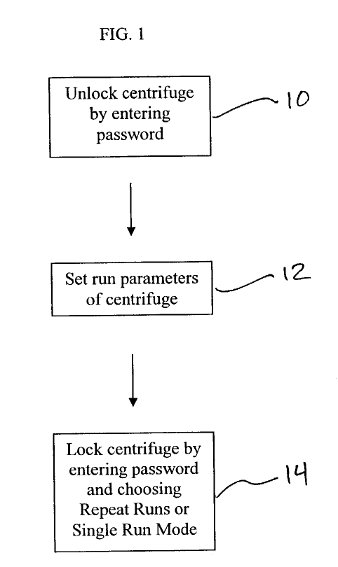

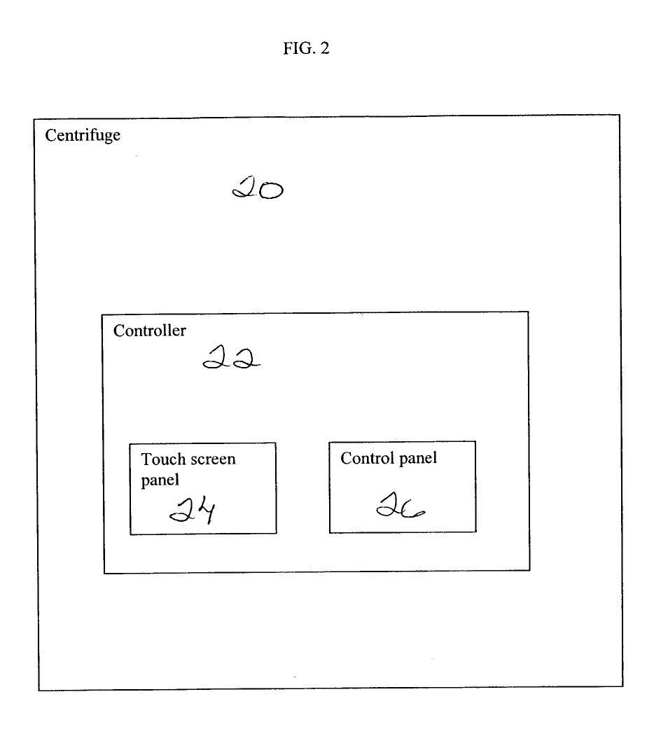

Referring to FIGS. 1 and 2, the steps of a method for operating a centrifuge are provided. FIG. 1 illustrates that the controller may be used to control the parameters of a centrifuge run, and the controller may be used to lock and unlock the centrifuge.

In the first step 10, a user chooses to unlock the centrifuge via a panel. The panel may be an LCD touch screen panel 24 or any other form suitable for receiving and transferring input from a user. In some cases, the centrifuge 20 may already be unlocked. The user then operates a control panel 26 to set the parameters of the centrifuge 20. This can only be done when the centrifuge 20 is unlocked. And, preferably, the control panel 26 can only be operated by a user with a supervisory password. The two panels 24, 26 may be integrated or separate.

The user can choose to set any run parameters of the centrifuge 20, including choice of rotor, length of run, speed of rotor, and temperature inside the centrifuge. The user can also choose to run the centrifuge 20 in rpm mode (revolutions per minute) or fcf (g-force) mode. The user also has the option of choosing the method of starting and stopping the rotor of the centrifuge 20. The user may choose three different start/stop configurations. One configuration allows the rotor to coast to a stop, thus using no power to stop the rotor from spinning at the end of a run. A second configuration increases the rotor speed by 500 rpm every 2 minutes ±30 seconds upon starting the run. The rotor speed is also decreased at this rate upon stopping A third configuration increases the rotor speed by 500 rpm every 1 minute ±30 seconds when starting. The rotor is stopped at the same rate at the end of a run. After setting each of the relevant parameters, the user can choose to lock the centrifuge via the touch screen panel 24.

When a user chooses to lock the centrifuge 20, the touch screen panel 24 will prompt the user for a password. A password is entered. If the password entered is valid, the user has the choice of selecting the lock mode. The options, whose choice will lock the centrifuge 20, can be such as “Repeat Run” mode or “Single Run” mode 30. After the mode selection is made, the centrifuge 20 is locked in that mode. The unlock screen 40 then appears. The centrifuge 20 can only be unlocked by an appropriate user. That is, if a supervisory password was used to lock the centrifuge 20, only a supervisory password can be used to unlock it. However, if the centrifuge 20 has been locked by an end user password, an end user password may also be used to unlock the centrifuge 20.

When the centrifuge 20 is locked, a user may only choose to start and stop the centrifuge 20. The parameters cannot be changed when the centrifuge 20 is locked. If one of the stored parameters is the length of the run, no options will be available to the user except to start the run. However, if the length of the run is not set, the user may choose a timed run, which permits the user to stop the centrifuge after any period of time he chooses.

If the lock mode was set to “Single Run”, the centrifuge 20 can only be run once after being locked. After one run has been performed, the only option will be to unlock the centrifuge 20. The start button will not be operative. If the lock mode was set to “Repeat Runs” on the other hand, the centrifuge 20 can be used multiple times employing the parameters that have been set.

It is important to note that if the power to the centrifuge 20 is turned off and then on again, the controller 22 will still be locked. The previous state of the centrifuge 20 cannot be overridden by simply turning the system off and on. This ensures that the set parameters cannot be changed by one without a proper password.

FIG. 2 illustrates a separation system having a centrifuge 20 and a controller 22 according to the present invention. The controller 22 has a touch screen 24 that permits locking the centrifuge in single run or repeat run mode. The controller 22 also has a control panel 26 that permits a supervisor to set the parameters of the centrifuge 20, as discussed above. As mentioned in connection with FIG. 1 above, the two panels 24, 26 may be integrated or separate.

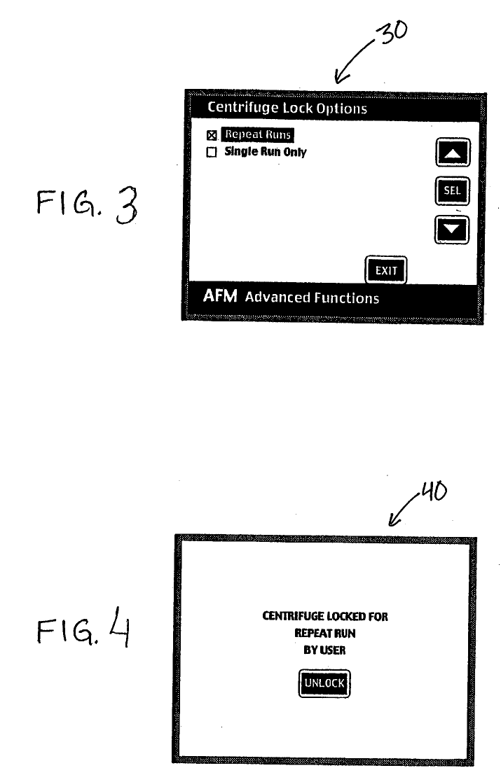

As depicted in FIG. 3, a preferred embodiment of the invention provides a touch screen interface 30 permitting a user to lock the centrifuge 20 in Repeat Run mode or Single Run mode. This lock can have supervisory password as well as multiple end user password capability. The supervisory password would allow a supervisor to limit the use of the centrifuge 20 to a single run or multiple runs.

Referring to FIG. 3, a user chooses to lock a previously unlocked centrifuge 20. Upon choosing to lock the centrifuge 20 and entering a valid password, the user is taken to the screen shown in FIG. 3. After choosing either Repeat Run mode or Single Run mode, the centrifuge 20 is locked in that mode until unlocked by an appropriate user. An end user password can only unlock the centrifuge 20 when it was used to lock the unit; a supervisory password can unlock the centrifuge regardless of what password was used to lock the unit.

FIG. 4 depicts the Repeat Run mode interface 40 that appears to a user after the centrifuge 20 has been locked in Repeat Run mode by a preferred embodiment of the present invention. Repeat Run mode deactivates all controls on the control panel 26 so that the set run parameters cannot be changed by an end user (i.e., START and STOP are the only active keys). This selection allows only a single set of run parameters to be performed over and over, until the centrifuge 20 is unlocked. Single Run Only mode similarly deactivates controls so that set parameters cannot be changed, but it also limits the functionality of START and STOP keys so that they will work only once. This mode disallows all subsequent use of the centrifuge 20 until it is unlocked.

Use of the centrifuge lock may offer considerable advantages by restricting centrifuge use, preventing unauthorized run parameter or program memory changes, or reducing the possibility for operator error, thus improving process control.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described and, accordingly, all suitable modifications and equivalents may be resorted to, falling within the scope of the invention.

What is claimed is:

1. A separation system, comprising:
a centrifuge; and
a controller connected to said centrifuge,
wherein said controller accepts a password used to operate the separation system.

2. The separation system of claim 1, wherein the password locks and unlocks the separation system.

3. The separation system of claim 2, wherein the centrifuge is locked in at least one of repeat run mode and single run mode.

4. The separation system of claim 1, wherein the password grants access to the separation system for the purpose of setting run parameters for the centrifuge.

5. The separation system of claim 4, wherein the run parameters comprise a group consisting of a rotor, length of run, speed of said rotor, temperature of the centrifuge, and a mode for starting and stopping the centrifuge.

6. The separation system of claim 1, wherein the password is at least one of a supervisory password and an end user password.

7. A centrifuge software lock, comprising:
a controller, wherein said controller accepts a password used to operate the separation system.

8. The centrifuge software lock of claim 7, wherein the password locks and unlocks the separation system.

9. The centrifuge software lock of claim 8, wherein the centrifuge is locked in at least one of repeat run mode and single run mode.

10. The centrifuge software lock of claim 7, wherein the password grants access to the separation system for the purpose of setting run parameters for the centrifuge.

11. The centrifuge software lock of claim 10, wherein the run parameters comprise a group consisting of a rotor, length of run, speed of said rotor, temperature of the centrifuge, and a mode for starting and stopping the centrifuge.

12. The centrifuge software lock of claim 7, wherein the password is at least one of a supervisory password and an end user password.

13. A method for limiting the function of a centrifuge, comprising the steps of:
unlocking the centrifuge;
entering run parameters for the centrifuge; and
locking the centrifuge.

14. The method of claim 13, wherein unlocking the centrifuge further comprises the step of entering a password.

15. The method of claim 14, wherein the password is one of at least a supervisory password and an end user password.

16. The method of claim 13, wherein the run parameters comprise a group consisting of a rotor, length of run, speed of said rotor, temperature of the centrifuge, and a mode for starting and stopping the centrifuge.

17. The method of claim 13, wherein the step of locking the centrifuge further comprises the step of entering a password and choosing a run mode for the centrifuge.

18. The method of claim 17, wherein the run mode permits at least one of repeat runs of the centrifuge and a single run of the centrifuge.

19. The method of claim 17, wherein the password is at least one of a supervisory password and an end user password.

20. A separation system, comprising:
a centrifuge;
means for unlocking the centrifuge;
means for entering run parameters for the centrifuge; and
means for locking the centrifuge.

21. The separation system of claim 20, wherein said means for unlocking is a touch screen panel connected to a controller.

22. The separation system of claim 20, wherein said means for entering run parameters is a control panel connected to a controller.

23. The separation system of claim 20, wherein said means for locking is a touch screen panel connected to a controller.
